(19) United States
(12) Patent Application Publication
(10) Pub. No.: US 2006/0064925 A1
(43) Pub. Date: Mar. 30, 2006

(54) Pest repellant supporting rack system

(76) Inventor: Mary Morgan, Richmond, VA (US)

Correspondence Address: John H. Thomas, P.C., 1561 East Main Street, Richmond, VA, 23219, US

(21) Appl. No.: 10/948,991

(22) Filed: Sep. 24, 2004

(51) Int. Cl. A01M 13/00

(52) U.S. Cl. 43/125

(57) ABSTRACT

A pest repellant system includes a rack and a web of pest repellant material. The web is mounted onto the rack in a flat configuration. The rack includes a permeable grid that allows for circulation of air around the web to disperse and spread the pest repellant material.

This invention relates to a pest repellant system and to a particular rack that supports a web of pest repellant material. The web is supported in a raised position to allow air to circulate around and through the web.

### BACKGROUND

Many types of pest repellant systems are known and used. The systems typically involve the delivery of a pest repellant to an area of interest. In the example of insect type pest repellants, the system may include the use of smoke (citronella candle or repellant burning coil) or aerosol sprays. Other well-known examples of pest repellant systems include fly paper and glue traps.

Recently, a popular remedy for use as a pest repellant includes the use of fabric softener sheets. Apparently, the scent from the fabric softener sheets repels insects and rodents. People may wear the sheets tucked into their hats or collar to keep insects away. However, there is no convenient and efficient system to mount fabric softener sheets, for instance, on a porch, patio, or crawl space. If the sheets are merely left on the ground, then their effectiveness is reduced, because air is only able to circulate over the top of the sheet. Leaving a sheet lying on a piece of furniture or porch surface may also be messy and leave a stain.

### SUMMARY

Accordingly, it is an object of the present invention to overcome drawbacks and limitations of prior systems and to provide a support rack system that carries a web containing pest repellant material to allow for circulation all around the web of material to disperse and spread the pest repellant material.

In one example, a pest repellant system comprises a web comprising a volatile, pest repellant material. The system further includes a rack adapted to support the web in a raised position, the rack comprising a pedestal and a permeable grid, wherein the pedestal is connected to and supports the permeable grid, and the permeable grid is adapted to releasably secure at least a portion of the web in a substantially flat configuration. The system allows air to circulate around the web to disperse the pest repellant material. The system may further comprise a second permeable grid releasably attached to the first grid, and wherein the web of pest repellant material is sandwiched, at least in part, between the first and second grids. The pedestal may be connected to the grid such that a base of the pedestal is substantially perpendicular to the grid. The second permeable grid may be connected to and supported by a second pedestal. Substantially the entire web may be sandwiched between the permeable grids. The rack may be substantially all metal or all plastic. The web may be impregnated with pest repellant material, or the web may be formed, at least in part, of pest repellant material. The web may be a fabric softener sheet. The system may include a table top attached to the top of the rack, wherein the table top is fixed in a substantially horizontal position when the rack is placed on a substantially horizontal surface. The rack may further include a hook whereby the system may be hung.

In another example, a rack is adapted to support a web of pest repellant material in a raised position. The rack comprises a pedestal connected to a permeable grid, wherein the grid is in a raised position. The permeable grid may be adapted to releasably secure at least a portion of a pest repellant web in a substantially flat configuration. The rack may further comprise a second permeable grid releasably attached to the first grid, and the web of pest repellant material may be sandwiched, at least in part, between the first and second grids. The pedestal may be connected to the grid such that a base of the pedestal is substantially perpendicular to the grid. The second permeable grid may be connected to and supported by a second pedestal.

### BRIEF DESCRIPTION OF THE DRAWINGS

FIG. 1 is a perspective view of a prototype of a system described herein.

FIG. 2 is a perspective, exploded view of the system shown in FIG. 1.

FIG. 3 is a perspective view of an alternative example of a system described herein.

FIGS. 4 and 4A are perspective and side elevation views respectively of another example of a system described herein.

### DETAILED DESCRIPTION

The pest repellant system includes a web of pest repellant material mounted, at least in part, on a rack. The rack includes a permeable grid which holds the web flat. The rack may further have a pedestal to hold the grid and support it in a raised position.

While the present invention is discussed in the context of several examples, it is not limited to those examples. Those of skill in the art will be able to take the teachings herein and find variations of pest repellant systems that are within the scope of this invention.

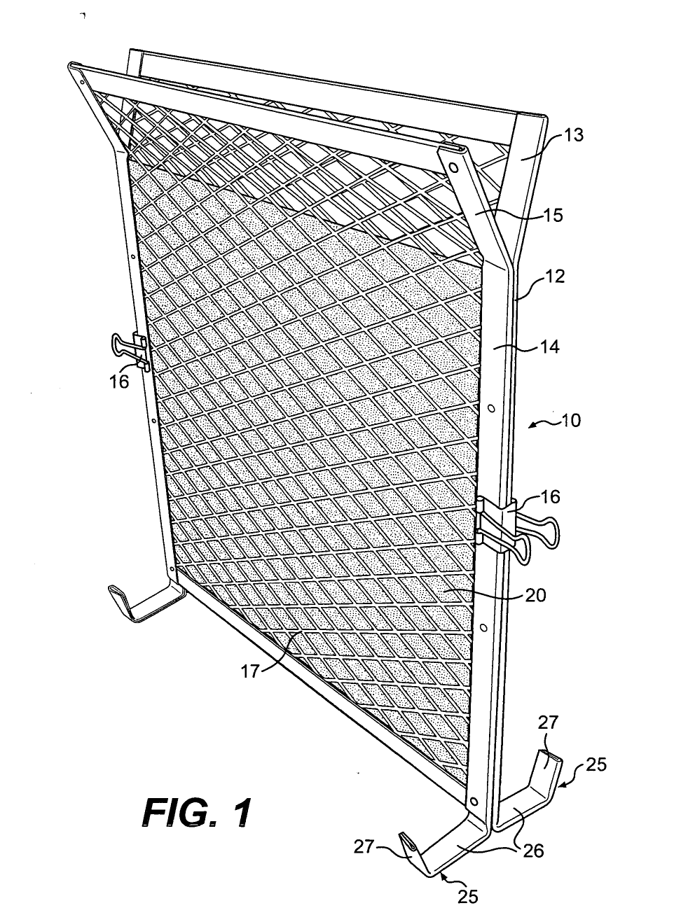

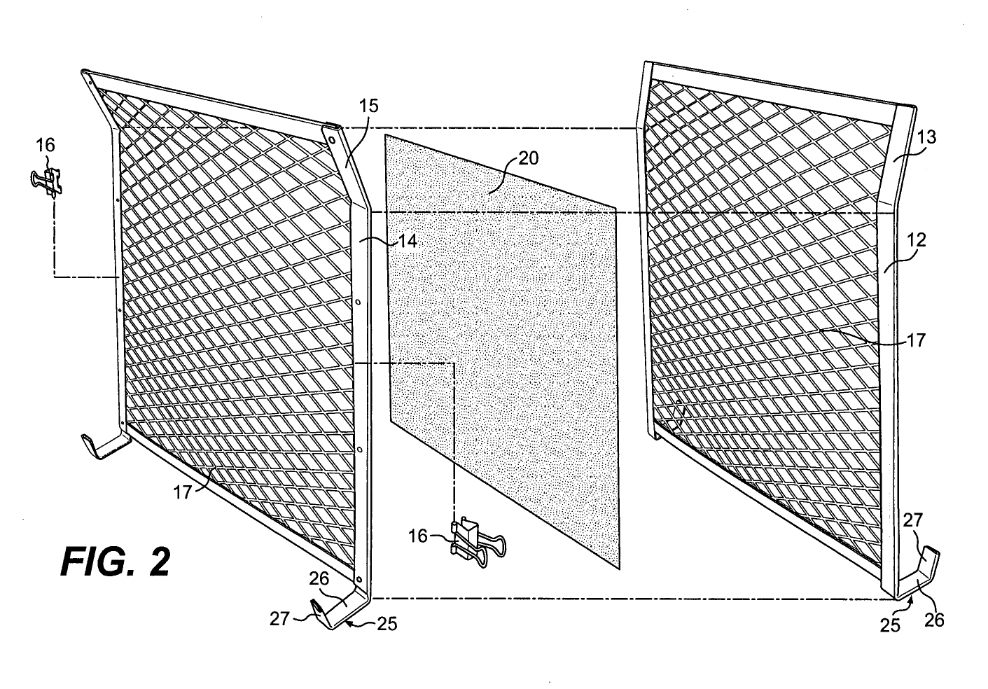

FIGS. 1 and 2 illustrate a prototype of a pest repellant system 10. The system 10 includes racks 12 and 14 that are releasably attached to each other through use of clips 16. Sandwiched between the racks 12 and 14 is a web 20 containing pest repellant material. The racks 12 and 14 include top portions 13 and 15 respectively that flare outwardly and away from each other. The racks 12 and 14 are further connected to pedestals 25 that include a base portion 26 and a raised end piece 27 that may act as a hook that allows the system 10 to be hung. The racks 12 and 14 include permeable grid portions 17 that are metal screens retained within those racks.

The web 20 contains a volatile, pest repellant material. The web may be woven fibers, non-woven fibers, knitted material, film or other substrate. The pest repellant material may be a part of the web, i.e., part of the fibers or film that make up the web. Alternatively, the pest repellant material may be impregnated into or onto the web. The pest repellant material is a volatile substance so that at least some of the material may be dispersed into the surrounding air. The pest repellant material may be one or more of many different materials depending on the purpose. For instance, a material that is highly volatile may only be effective for a short term (hours), while an alternative pest repellant may have less volatility and be effective for longer terms, potentially days or weeks. Also, the pest repellant material may vary depending on the targeted pest. One compound may be desirable to repel mosquitos and flies from a porch or patio. Another material may act to repel rodents in basements or crawl spaces. One example of a web having a pest repellant material impregnated into it is a fabric softener sheet. Acceptable fabric softener sheets include Bounce®, Downy®, and other house brands.

The term “flat” used herein means laid in a generally unfolded, unbunched configuration. The web is laid flat so that the entire web (corresponding to the size of the rack) is available for circulation of air around it. The term “flat” is not limited to planar, but it may include curved, waffled, fluted or wavy surfaces. The web may have a larger area or smaller area than the area of the rack.

The racks have a permeable grid that may be a screen or other support that maintains the web in a flat position. The shape of the grid may also vary from the rectangular shape shown in the drawings. A grid could be round, oval, curved or other geometric shape. The system shown has the ease of replacement of the web. Also, the rack material may be metal or plastic or any other materials or combination thereof. It may be desirable for weight purposes to have a heavy rack to withstand wind. Alternatively, a light weight plastic material may be sufficient to hold flat the pest repellant resistant material web and make a light weight system that may be hung or suspended from a wire or wall.

The pedestal 25 has a base 26 generally perpendicular to the plane of the racks 12 and 14. The pedestal 25 may be connected to the racks 12 and 14 in other ways to effect other angles with respect to a support surface on which the system may be placed. The pedestal 25 also has a hook 27 component to allow the system to be suspended from a wire or door. The hook 27 may be flat or curved, it is merely necessary that the hook have geometry to allow the system to be suspended.

In operation, a user will separate a pair of racks 12 and 14 in order to insert or replace a web 20. The racks 12 and 14 are then reattached to each other so that the web 20 is sandwiched between them. The clips 16 shown could be any means of releasable attachment of the various racks. Other means of securing the racks include hook and loop fasteners, snaps, clips, clamps, magnets, adhesive, etc. Also, the second rack 14 is shown with its own pedestal, but this is not necessary. A second rack does not require a pedestal.

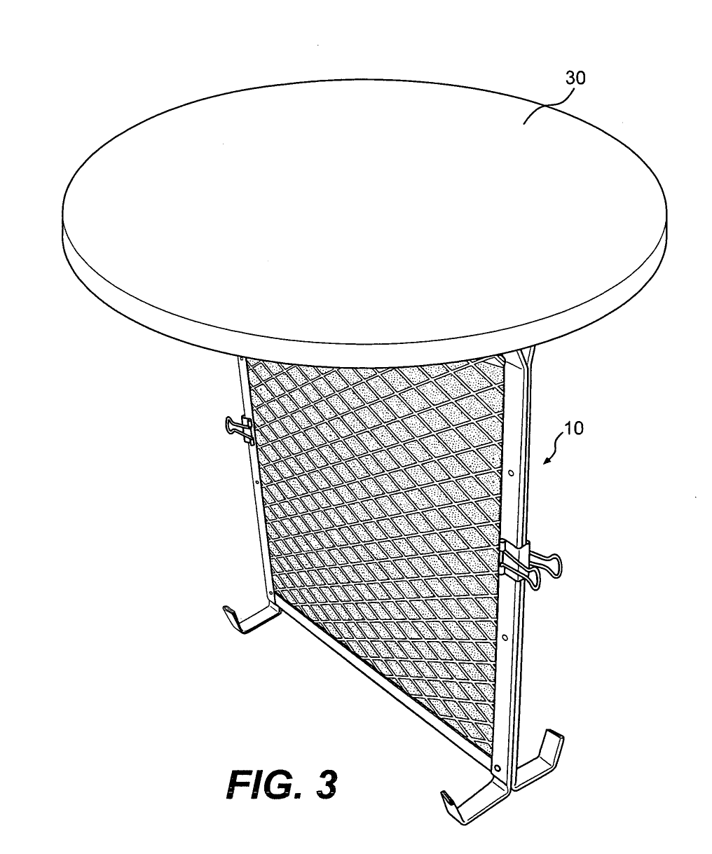

FIG. 3 is a further variation of a pest repellant system where the system 10 supports a table top 30. The top 30 may be releasably fixed or hingedly connected to the system 10 to allow a user access to the system to install or replace a pest repellant web of material. FIG. 3 is merely on example of how to incorporate the pest repellant system into furniture or other decorative items. Of course, there will be other types of furniture or decorative items that may incorporate a pest repellant system as described herein. These other items include, but are not limited to, a fixed top and/or bottom surface to the rack, a candle holder, a foot stool, and a porch swing.

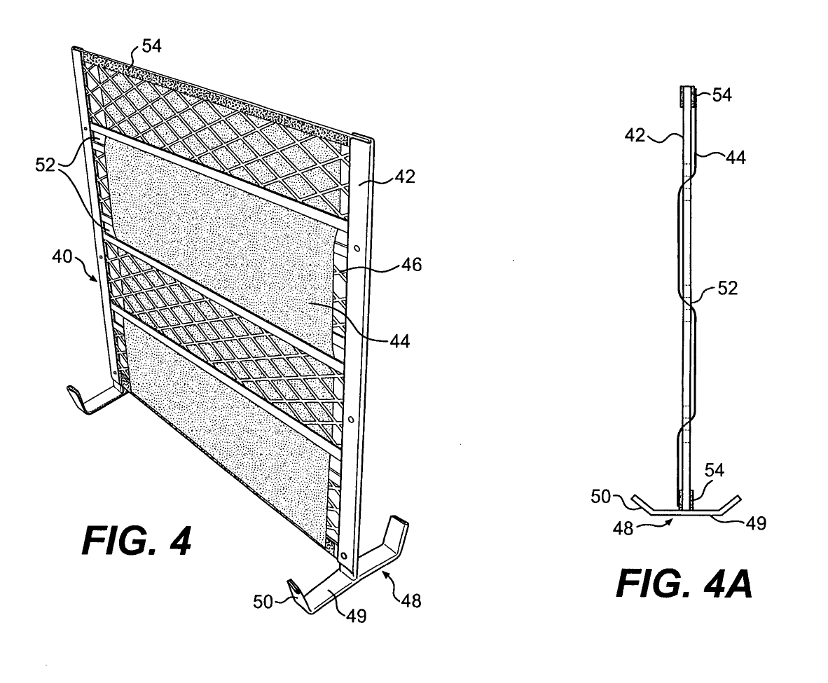

FIG. 4 is another example of a pest repellant system. In FIG. 4, the system 40 includes a single rack 42. The rack 42 has slots 52 therein. There are permeable grids 46 mounted on the rack 42 and in between the slots 52. The rack 42 is mounted onto a pedestal 48 and includes a base portion 49 and hook portion 50. The web 44 of pest repellant material is woven into the single rack 42. The web 44 is connected at the top of the rack by a fastener 54 and at the bottom of the rack by a second fastener 54. Those fasteners may include snaps, hook and loop construction, hooks, clamps, clips, magnets, adhesives, or any other means to attach the web 44 onto the rack 42.

While the invention has been described with reference to specific embodiments thereof, it will be understood that numerous variations, modifications and additional embodiments are possible, and all such variations, modifications, and embodiments are to be regarded as being within the spirit and scope of the invention.

What is claimed is:

1. A pest repellant system comprising:
a web comprising a volatile, pest repellant material;
a rack adapted to support the web in a raised position, the rack comprising a pedestal and a permeable grid, wherein the pedestal is connected to and supports the permeable grid and the permeable grid is adapted to releasably secure at least a portion of the web in a substantially flat configuration;
whereby air is allowed to circulate around the web to disperse the pest repellant material.

2. The pest repellant system described in claim 1, further comprising a second permeable grid releasably attached to the first grid, and wherein the web of pest repellant material is sandwiched, at least in part, between the first and second grids.

3. The pest repellant system described in claim 1, wherein the pedestal is connected to the grid such that a base of the pedestal is substantially perpendicular to the grid, whereby the web is supported in a substantially vertical orientation when the base is placed on a substantially horizontal surface.

4. The pest repellant system described in claim 2, wherein the second permeable grid is connected to and supported by a second pedestal,
whereby the system is supported by a pair of pedestals.

5. The pest repellant system described in claim 2, wherein substantially the entire web is sandwiched between the permeable grids.

6. The pest repellant system described in claim 1, wherein the rack is substantially all metal.

7. The pest repellant system described in claim 1, wherein the rack is substantially all plastic.

8. The pest repellant system described in claim 1, wherein the web is impregnated with pest repellant material.

9. The pest repellant system described in claim 1, wherein the web is formed, at least in part, of pest repellant material.

10. The pest repellant system described in claim 1, wherein the web is a fabric softener sheet.

11. The pest repellant system described in claim 1, further comprised of a table top attached to the top of the rack, wherein the table top is fixed in a substantially horizontal position when the rack is placed on a substantially horizontal surface.

12. The pest repellant system as described in claim 1, the rack further comprising a hook, whereby the system may be hung.

13. A rack adapted to support a web of pest repellant material in a raised position, the rack comprising:
a pedestal connected to a permeable grid, wherein the grid is in a raised position, the rack comprising:
the permeable grid is adapted to releasably secure at least a portion of a pest repellant web in a substantially flat configuration.

14. A rack as described in claim 13, further comprising a second permeable grid releasably attached to the first grid, and the web of pest repellant material is sandwiched, at least in part, between the first and second grids.

15. A rack as described in claim 13, wherein the pedestal is connected to the grid such that a base of the pedestal is substantially perpendicular to the grid, whereby the web is supported in a substantially vertical orientation when the base is placed on a substantially horizontal surface.

16. A rack as described in claim 14, wherein the second permeable grid is connected to and supported by a second pedestal,
whereby the system is supported by a pair of pedestals.
